(19) United States
(12) Patent Application Publication
(10) Pub. No.: US 2021/0296736 A1
(43) Pub. Date: Sep. 23, 2021

(54) SOLID STATE BATTERY

(71) Applicant: Murata Manufacturing Co., Ltd., Nagaokakyo-shi (JP)

(72) Inventor: Osamu Chikagawa, Nagaokakyo-shi (JP)

(21) Appl. No.: 17/335,207

(22) Filed: Jun. 1, 2021

Related U.S. Application Data
(63) Continuation of application No. PCT/JP2019/043928, filed on Nov. 8, 2019.

(30) Foreign Application Priority Data
Dec. 6, 2018 (JP) 2018-229372

(51) Int. Cl. H01M 50/474; H01M 10/0525; H01M 10/0585

(52) U.S. Cl. CPC H01M 50/474; H01M 10/0585; H01M 10/0525

(57) ABSTRACT

A solid state battery including: at least two battery units arranged adjacent to each other along a stacking direction, each of the at least two battery units including a positive electrode layer, a negative electrode layer, and a solid electrolyte layer interposed between the positive electrode layer and the negative electrode layer; and an insulating layer between two adjacent battery units of the at least two battery units along the stacking direction, the insulating layer having a higher Young's modulus than that of the two adjacent battery units.

### CROSS REFERENCE TO RELATED APPLICATIONS

The present application is a continuation of International application No. PCT/JP2019/043928, filed Nov. 11, 2019, which claims priority to Japanese Patent Application No. 2018-229372, filed Dec. 6, 2018, the entire contents of each of which are incorporated herein by reference.

### FIELD OF THE INVENTION

The present invention relates to a solid state battery.

### BACKGROUND OF THE INVENTION

A secondary battery capable of being repeatedly charged and discharged have been conventionally used for various applications. For example, the secondary battery is used as a power source for an electronic device such as a smartphone or a notebook computer.

In the secondary battery, a liquid electrolyte (electrolytic solution) such as an organic solvent has been conventionally used as a medium for causing ions to move between an anode and a cathode. However, the secondary battery using the electrolytic solution causes a problem such as leakage of the electrolytic solution from a case. Therefore, the development of a solid state battery including a solid electrolyte instead of the liquid electrolyte has been proceeding to be developed.
Patent Document 1: Japanese Patent Application Laid-Open No. 2007-5279

### SUMMARY OF THE INVENTION

A typical solid state battery 500′ is shown in FIG. 6 and includes a battery unit including a positive electrode layer 10A′ and a negative electrode layer 10B′ that face each other, and a solid electrolyte layer 20′ interposed between the positive electrode layer 10A′ and the negative electrode layer 10B′. In some cases, at least such two battery units are provided along a stacking direction.

The positive electrode layer 10A′ may include a positive electrode current collecting layer 11A′ and a positive electrode active material layer 12A′. One end of the positive electrode current collecting layer 11A′ may be electrically connected to a positive electrode terminal 200A′. The negative electrode layer 10B′ may include a negative electrode current collecting layer 11B′ and a negative electrode active material layer 12B′. One end of the negative electrode current collecting layer 11B′ may be electrically connected to a negative electrode terminal 200B′. In such a constitution, the solid electrolyte layer 20′ may be tightly provided between the positive electrode layer 10A′ and the negative electrode layer 10B′ that face each other along the stacking direction.

Here, those skilled in the art have known that ions move in the solid electrolyte between the positive electrode layer 10A′ and the negative electrode layer 10B′ during the charge and discharge of the solid state battery 500′, so that the active material layers 12A′ and 12B′ of the electrode layers may expand and contract (see FIG. 6). The expansion and contraction of the active material layers 12A′ and 12B′ may cause some problems.

Specifically, when the active material layer expands and contracts during the charge and discharge of the solid state battery 500′, the solid electrolyte layer 20′ located between the positive electrode layer 10A′ and the negative electrode layer 10B′ may not expand and contract. Alternatively, if the solid electrolyte layer 20′ expands and contracts, the amounts of the expansion and contraction of the solid electrolyte layer 20′ may be smaller than those of each electrode layer. Therefore, this may cause a stress to occur in a compressive direction in the electrode layer and a stress to occur in a tensile direction in the solid electrolyte layer 20′ in the relationship between each electrode layer and the solid electrolyte layer 20′ in the stacking direction (see FIG. 6). Specifically, in the relationship between the positive electrode layer 10A′ and the solid electrolyte layer 20′ that is in contact with the positive electrode layer 10A′ in the stacking direction, the stress may occur in the compressive direction in the positive electrode layer 10A′, and the stress may occur in the tensile direction in the solid electrolyte layer 20′. In the relationship between the negative electrode layer 10B′ and the solid electrolyte layer 20′ that is in contact with the negative electrode layer 10B′ in the stacking direction, the stress may occur in the compressive direction in the negative electrode layer 10B′, and the stress may occur in the tensile direction in the solid electrolyte layer 20′. Therefore, cracks 40′ may occur in the solid electrolyte layer 20′ that is affected by such a stress (see FIG. 7). In not only the solid electrolyte layer but also a battery material, cracks may occur. The battery material is included in a solid state battery, and may not expand and contract during charge and discharge or has the amounts of expansion and contraction that may be reduced with respect to each electrode layer.

The present invention has been made in view of the above circumstances, and a main object of the present invention is to provide a solid state battery that can more suitably suppress the cracks of a battery material during the charge and discharge of the solid state battery.

In order to achieve the above object, an embodiment of the present invention provides a solid state battery including: at least two battery units arranged adjacent to each other along a stacking direction, each of the at least two battery units including a positive electrode layer, a negative electrode layer, and a solid electrolyte layer interposed between the positive electrode layer and the negative electrode layer; and an insulating layer between two adjacent battery units of the at least two battery units along the stacking direction, wherein the insulating layer has a higher Young's modulus than that of each of the two adjacent battery units.

The present invention can more suitably suppress the cracks of a battery material during the charge and discharge of a solid state battery.

### BRIEF EXPLANATION OF THE DRAWINGS

FIG. 1 is a sectional view schematically showing a solid state battery according to an embodiment of the present invention.

FIG. 2 is a sectional view schematically showing a solid state battery according to another embodiment of the present invention.

FIG. 3 is a sectional view schematically showing a solid state battery according to another embodiment of the present invention.

FIG. 4 is a sectional view schematically showing a solid state battery according to another embodiment of the present invention.

FIG. 5 is a sectional view schematically showing a solid state battery according to another embodiment of the present invention.

FIG. 6 is a sectional view schematically showing a conventional solid state battery that includes an active material layer expanding and contracting during charge and discharge.

FIG. 7 is a sectional view schematically showing a conventional solid state battery including a solid electrolyte layer in which cracks occur during charge and discharge.

### DETAILED DESCRIPTION OF THE INVENTION

Hereinafter, a “solid state battery” of aspects of the present invention will be described in detail. Although the description will be made with reference to the drawings as necessary, contents to be illustrated are merely schematically and exemplarily shown for understanding of the present invention, and the appearance and the dimensional ratio and the like can be different from those of an actual solid state battery.

The “solid state battery” as used in the present description refers to a battery composed of solid constituent elements in a broad sense, and a total solid state battery composed of solid constituent elements (particularly preferably all solid constituent elements) in a narrow sense. In a suitable aspect, the solid state battery of the present invention is a stacked-type solid state battery in which layers forming a battery unit are stacked, and each of such layers is preferably a sintered body. The “solid state battery” includes not only a so-called “secondary battery” allowing repeated charge and discharge but also a “primary battery” allowing only discharge. In a suitable aspect of the present invention, the “solid state battery” is the secondary battery. The “secondary battery” is not excessively limited by its name, and may include, for example, an electrochemical device such as “an electric storage device”.

A “sectional view” as used herein is a state viewed from a direction substantially perpendicular to a thickness direction based on the stacking direction of active material layers constituting the solid state battery.

The terms “vertical direction” and “horizontal direction” directly or indirectly used herein respectively correspond to a vertical direction and a horizontal direction in the drawings. Unless otherwise specified, the same reference signs or symbols denote the same members or parts, or the same semantic contents. In a suitable aspect, it can be understood that a vertical downward direction (that is, a direction in which gravity acts) corresponds to the term “downward direction” and the opposite direction corresponds to the term “upward direction”.

[Basic Constitution of Solid State Battery]

The solid state battery according to an aspect of the present invention includes a solid state battery stacked body that includes at least one battery unit including a positive electrode layer, a negative electrode layer, and a solid electrolyte layer interposed therebetween along a stacking direction.

The layers constituting this solid state battery may be formed by firing. That is, preferably, the positive electrode layer, the negative electrode layer, and the solid electrolyte layer and the like are sintered layers. More preferably, the positive electrode layer, the negative electrode layer, and the solid electrolyte are integrally fired, and therefore the battery unit is an integrally sintered body. Here, the term “integral firing” means that layers stacked in an unfired stacked body are simultaneously fired, and the layers in the unfired stacked body may be formed by any of methods such as a printing method (such as a screen printing method) and/or a green sheet method using a green sheet. The term “integrally sintered” means formation due to “integral firing,” and the term “integrally sintered body” means a product formed by “integral firing.”

The positive electrode layer is an electrode layer containing at least a positive electrode active material. The positive electrode layer may further contain a solid electrolyte material and/or a positive electrode current collecting layer. Preferably, the positive electrode layer is composed of a sintered body containing at least positive electrode active material grains, a solid electrolyte material, and a positive electrode current collecting layer. The negative electrode layer is an electrode layer containing at least a negative electrode active material. The negative electrode layer may further contain a solid electrolyte material and/or a negative electrode current collecting layer. Preferably, the negative electrode layer is composed of a sintered body containing at least negative electrode active material grains, a solid electrolyte material, and a negative electrode current collecting layer.

The positive electrode active material and the negative electrode active material are substances involved in the transfer of electrons in the solid state battery. Ions move (conduct) between the positive electrode layer and the negative electrode layer via the solid electrolyte layer to transfer the electrons for charge and discharge. The positive electrode layer and the negative electrode layer are particularly preferably layers capable of occluding and releasing lithium ions or sodium ions. That is, the solid state battery is preferably a total solid type battery secondary battery in which lithium ions or sodium ions move between a positive electrode layer and a negative electrode layer via a solid electrolyte layer to charge and discharge the battery.

(Positive Electrode Active Material)

Examples of the positive electrode active material contained in the positive electrode layer include at least one selected from the group consisting of a lithium-containing phosphate compound having a NASICON-type structure, a lithium-containing phosphate compound having an olivine-type structure, a lithium-containing layered oxide, and a lithium-containing oxide having a spinel-type structure. Examples of the lithium-containing phosphate compound having a NASICON-type structure include Li₃V₂(PO₄)₃. Examples of the lithium-containing phosphate compound having an olivine-type structure include Li₃Fe₂(PO₄)₃ and LiMnPO₄.

Examples of the lithium-containing layered oxide include LiCoO₂ and LiCo_{1/3}Ni_{1/3}Mn_{1/3}O₂. Examples of the lithium-containing oxide having a spinel-type structure include LiMn₂O₄ and LiNi_{0.5}Mn_{1.5}O₄.

Examples of the positive electrode active material capable of occluding and releasing sodium ions include at least one selected from the group consisting of a sodium-containing phosphate compound having a NASICON-type structure, a sodium-containing phosphate compound having an olivine-type structure, a sodium-containing layered oxide, and a sodium-containing oxide having a spinel-type structure, and the like.

(Negative Electrode Active Material)

Examples of the negative electrode active material contained in the negative electrode layer include at least one selected from the group consisting of an oxide containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing phosphate compound having an olivine-type structure, and a lithium-containing oxide having a spinel-type structure, and the like. Examples of the lithium alloy include Li—Al. Examples of the lithium-containing phosphate compound having a NASICON-type structure include Li₃V₂(PO₄)₃. Examples of the lithium-containing phosphate compound having an olivine-type structure include Li₃Fe₂(PO₄)₃. Examples of the lithium-containing oxide having a spinel-type structure include Li₄Ti₅O₁₂.

Examples of the negative electrode active material capable of occluding and releasing sodium ions include at least one selected from the group consisting of a sodium-containing phosphate compound having a NASICON-type structure, a sodium-containing phosphate compound having an olivine-type structure, and a sodium-containing oxide having a spinel-type structure, and the like.

The positive electrode layer and/or the negative electrode layer may contain an electron conductive material. Examples of the electron conductive material contained in the positive electrode layer and/or the negative electrode layer include at least one selected from the group consisting of metal materials such as silver, palladium, gold, platinum, aluminum, copper, and nickel, and carbon and the like. Although not particularly limited, copper is preferable because it is less likely to react with the positive electrode active material, the negative electrode active material, and the solid electrolyte material and the like, and is effective in reducing the internal resistance of the solid state battery.

The positive electrode layer and/or the negative electrode layer may contain a sintering aid. Examples of the sintering aid include at least one selected from the group consisting of lithium oxide, sodium oxide, potassium oxide, boron oxide, silicon oxide, bismuth oxide, and phosphorus oxide.

The thicknesses of the positive and negative electrode layers are not particularly limited, and may be each independently, for example, 2 μm to 50 μm, and particularly 5 μm to 30 μm.

(Solid Electrolyte)

The solid electrolyte is a material capable of conducting lithium ions or sodium ions. In particular, the solid electrolyte of the battery unit of the solid state battery forms a layer in which lithium ions can be conducted between the positive electrode layer and the negative electrode layer. The solid electrolyte may be provided at least between the positive electrode layer and the negative electrode layer. That is, the solid electrolyte may also be present around the positive electrode layer and/or the negative electrode layer so as to protrude from between the positive electrode layer and the negative electrode layer. Specific examples of the solid electrolyte include a lithium-containing phosphate compound having a NASICON structure, an oxide having a perovskite structure, and an oxide having a garnet-type or garnet-type similar structure. Examples of the lithium-containing phosphate compound having a NASICON structure include LiₓM_{y}(PO₄)₃ (where 1≤x≤2, 1≤y≤2, and M is at least one selected from the group consisting of Ti, Ge, Al, Ga, and Zr). Examples of the lithium-containing phosphate compound having a NASICON structure include Li_{1.2}Al_{0.2}Ti_{1.8}(PO₄)₃. Examples of the oxide having a perovskite structure include La_{0.55}Li_{0.35}TiO₃. Examples of the oxide having a garnet-type or garnet-type similar structure include Li₇La₃Zr₂O₁₂.

Examples of the solid electrolyte in which sodium ions can be conducted include a sodium-containing phosphate compound having a NASICON structure, an oxide having a perovskite structure, and an oxide having a garnet-type or garnet-type similar structure. Examples of the sodium-containing phosphate compound having a NASICON structure include NaₓM_{y}(PO₄)₃ (where 1≤x≤2, 1≤y≤2, and M is at least one selected from the group consisting of Ti, Ge, Al, Ga, and Zr.).

The solid electrolyte layer may contain a sintering aid. The sintering aid contained in the solid electrolyte layer may be selected from, for example, the sintering aids that may be contained in the positive electrode layer and/or the negative electrode layer.

The thickness of the solid electrolyte layer is not particularly limited, and may be, for example, 1 μm to 15 μm, and particularly 1 μm to 5 μm.

(Positive Electrode Current Collecting Layer/Negative Electrode Current Collecting Layer)

As a positive electrode current collecting material constituting the positive electrode current collecting layer and a negative electrode current collecting material constituting the negative electrode current collecting layer, a material having a high conductivity is preferably used. For example, as each of the positive electrode current collecting material and the negative electrode current collecting material, at least one selected from the group consisting of silver, palladium, gold, platinum, aluminum, copper, and nickel and the like is preferably used. In particular, copper is preferable because it is less likely to react with the positive electrode active material, the negative electrode active material, and the solid electrolyte material, and is effective in reducing the internal resistance of the solid state battery.

Each of the positive electrode current collecting layer and the negative electrode current collecting layer may include an electrical connecting part for providing electric connection to the outside, and be configured to be electrically connectable to a terminal. Each of the positive electrode current collecting layer and the negative electrode current collecting layer may have a foil form. From the viewpoint of improving electron conductivity and reducing manufacturing cost by integral sintering, each of the positive electrode current collecting layer and the negative electrode current collecting layer preferably has an integrally sintered form. When the positive electrode current collecting layer and the negative electrode current collecting layer have a sintered body form, each of them may be composed of, for example, a sintered body containing an electron conductive material and a sintering aid.

The electron conductive material contained in each of the positive electrode current collecting layer and the negative electrode current collecting layer may be selected from, for example, the electron conductive materials that may be contained in the positive electrode layer and/or the negative electrode layer. The sintering aid contained in each of the positive electrode current collecting layer and the negative electrode current collecting layer may be selected from, for example, the sintering aids that may be contained in the positive electrode layer and/or the negative electrode layer.

The thickness of each of the positive electrode current collecting layer and the negative electrode current collecting layer is not particularly limited. For example, the thickness of each of the positive electrode current collecting layer and the negative electrode current collecting layer may be 1 μm to 5 μm, and particularly 1 μm to 3 μm.

(Insulating Layer)

An insulating layer may be formed between one battery unit and the other battery unit adjacent to each other along the stacking direction, whereby the movement of ions between the adjacent battery units is avoided to prevent excessive occlusion and release of the ions. Although not particularly limited, the insulating layer may be composed of, for example, a glass material, a ceramic material, and/or a sintering aid and the like. In a suitable aspect, for example, a glass material may be selected as the insulating layer. Examples of the glass material include, but are not particularly limited to, at least one selected from the group consisting of soda lime glass, potash glass, borate-based glass, borosilicate-based glass, barium borosilicate-based glass, zinc borate-based glass, barium borate-based glass, bismuth borosilicate-based glass, bismuth zinc borate-based glass, bismuth silicate-based glass, phosphate-based glass, aluminophosphate-based glass, and zinc phosphate-based glass. Examples of the ceramic material include at least one selected from the group consisting of alumina, zirconia, spinel, and forsterite.

The insulating layer may contain a sintering aid. The sintering aid contained in the insulating layer may be selected from, for example, the sintering aids that may be contained in the positive electrode layer and/or the negative electrode layer.

The thickness of the insulating layer is not particularly limited, and may be, for example, 1 μm to 15 μm, and particularly 1 μm to 5 μm.

(Protective Layer)

A protective layer may be generally provided on the outermost side of the solid state battery, and electrically, physically, and/or chemically protects the solid state battery stacked body. It is preferable that a material constituting the protective layer has excellent insulation properties, durability, and/or moisture resistance, and is environmentally safe. For example, it is preferable to use a glass material, a ceramic material, a thermosetting resin, and/or a photocurable resin and the like.

(Terminal)

The solid state battery generally includes a terminal (for example, an external terminal). In particular, the terminal is provided on each of side surfaces of the solid state battery. More specifically, a positive electrode-side terminal connected to the positive electrode layer and a negative electrode-side terminal connected to the negative electrode layer may be provided so as to face each other. A material having a high conductivity is preferably used for the terminal. Examples of the material of the terminal include, but are not particularly limited to, at least one selected from the group consisting of silver, gold, platinum, aluminum, copper, tin, and nickel.

[Distinguishing Portion of Solid State Battery of the Present Invention]

A distinguishing portion of the solid state battery according to an embodiment of the present invention will be described below in consideration of the basic constitution of the solid state battery.

The present inventors have diligently examined solutions in order to more suitably suppress the occurrence of cracks in the battery materials during the charge and discharge of the solid state battery in the case where the solid state battery includes the battery materials tightly arranged together. As a result, the present inventors have come up with solutions based on a technique that is not an extension of a conventional technique when at least two battery units (including a positive electrode layer, a negative electrode layer, and a solid electrolyte layer interposed between the positive electrode layer and the negative electrode layer) are provided along a stacking direction.

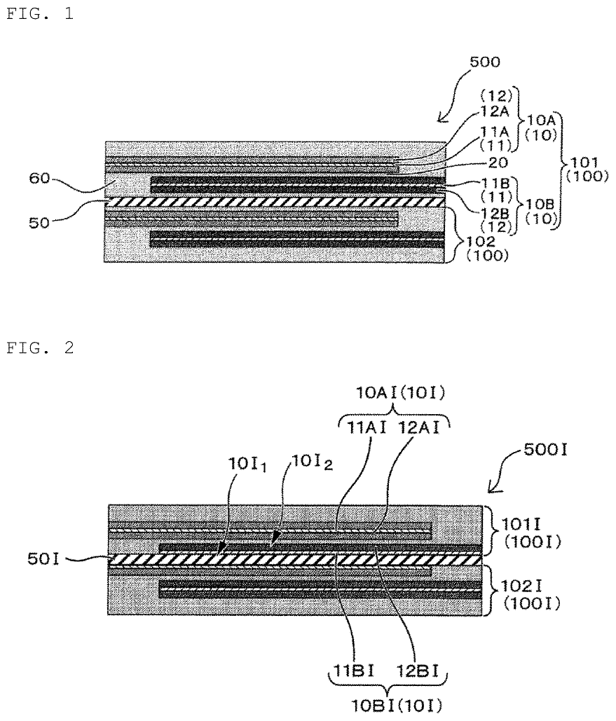

The present inventors discovered that when an insulating layer 50 having a higher Young's modulus than that of a battery material (for example, at least one of a positive electrode layer 10A, a negative electrode layer 10B, and a solid electrolyte layer 20, or an integrated product thereof) of battery units 100 is provided between one battery unit 101 (100) and the other battery unit 102 (100) adjacent to each other along a stacking direction in a solid state battery 500 (see FIG. 1), the generation of cracks in the battery materials can be suppressed.

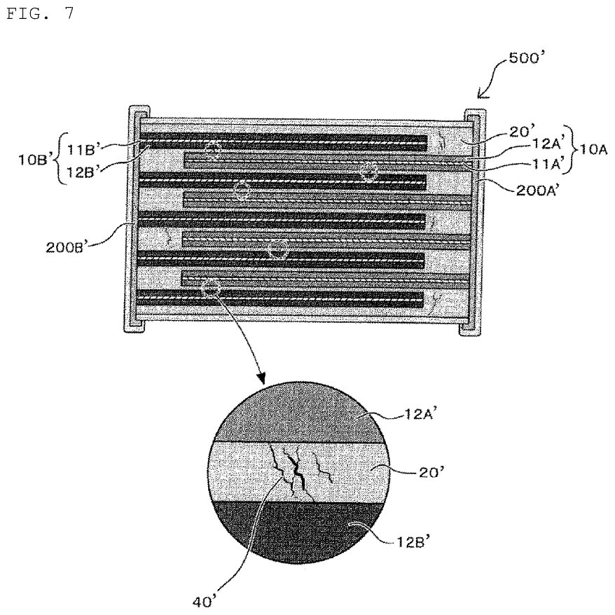

In this regard, in a conventional solid state battery 500′ (see FIG. 6), one battery unit and the other battery unit adjacent to each other along a stacking direction may be in continuous form via a solid electrolyte layer 20′. Specifically, in the conventional solid state battery 500′, the solid electrolyte layer 20′ is in a continuous form between a positive electrode (or a negative electrode) included in one battery unit and a negative electrode (or a positive electrode) directly facing the positive electrode (or the negative electrode) and included in the other battery unit.

Meanwhile, according to the present invention, as shown in the sectional view exemplified in FIG. 1, the insulating layer 50 causes the solid electrolyte layer 20 to be in a discontinuous form in a region between a positive electrode (or a negative electrode) included in one battery unit 101 and a negative electrode (or a positive electrode) facing the positive electrode (the negative electrode) and included in the other battery unit 102 adjacent thereto. That is, the solid electrolyte layer 20 is divided into two by the insulating layer 50. Here, the insulating layer 50 has a higher Young's modulus than that of the battery material constituting the battery unit 100. That is, the Young's modulus of the insulating layer 50 is preferably higher than that of each of the positive electrode layer 10A, the negative electrode layer 10B, and the solid electrolyte layer 20. Conversely, the Young's modulus of each of the positive electrode layer 10A, the negative electrode layer 10B, and the solid electrolyte layer 20 is lower than that of the insulating layer 50. The Young's modulus may be the Young's modulus of each of a plurality of target layers that are present, or the Young's modulus of a single body obtained by considering the plurality of layers as the single body. Therefore, in the present description, the “Young's modulus of the positive electrode layer, the negative electrode layer, and the solid electrolyte layer” may be the Young's modulus of each of the positive electrode layer, the negative electrode layer, and the solid electrolyte layer, or the Young's modulus of a single integrated body when the positive electrode layer, the negative electrode layer, and the solid electrolyte layer are totally regarded as the single integrated body.

The above constitution can more suitably suppress the cracks of the battery materials that may occur due to the expansion and contraction of the electrode layer during the charge and discharge of the solid state battery. Specifically, the insulating layer 50 has high rigidity, whereby the insulating layer 50 can have strength capable of suppressing the cracks of the battery materials that may occur due to deformation caused by the expansion and contraction of the electrode layer. The insulating layer 50 divides the battery unit 101 and the battery unit 102 from each other, whereby the propagation of a stress (strain) between the battery units can be prevented. Thereby, the cracks of the battery materials that may occur during charge and discharge can be more suitably suppressed.

The “insulating layer” in the present description refers to a layer composed of a material that does not allow electrons and ions to pass through the layer, that is, a material having electron insulating properties and ion insulating properties in a broad sense, and a layer composed of an insulating material in a narrow sense. Although not particularly limited, the insulating layer may contain, for example, a glass material, a ceramic material, and/or a sintering aid and the like.

The insulating layer is composed of the ion insulating material whereby the movement of the ions between the battery units can be prevented. This makes it possible to reduce the expansion and contraction of the electrode layer due to the movement of the ions between the battery units. Therefore, the cracks of the battery materials that may occur during charge and discharge can be more suitably suppressed.

The material constituting the insulating layer may be, for example, a glass material and/or a ceramic material. Although not particularly limited, the glass material may contain at least one selected from the group consisting of soda lime glass, potash glass, borate-based glass, borosilicate-based glass, barium borosilicate-based glass, zinc borate-based glass, barium borate-based glass, bismuth borosilicate-based glass, bismuth zinc borate-based glass, bismuth silicate-based glass, phosphate-based glass, aluminophosphate-based glass, and zinc phosphate-based glass.

The ceramic material may contain at least one selected from the group consisting of alumina, zirconia, spinel, and forsterite.

Herein, the “battery material” means a portion constituting a solid state battery in a broad sense, and refers to at least one of a positive electrode layer, a negative electrode layer, a solid electrolyte layer, a positive electrode current collecting layer, a negative electrode current collecting layer, a protective layer, and an insulating layer (an insulating layer other than an insulating layer interposed between battery units) in a narrow sense. In a suitable aspect, the battery material is a solid state battery stacked body composed of at least a positive electrode layer, a negative electrode layer, and a solid electrolyte layer.

In a suitable aspect, the insulating layer has a lower coefficient of thermal expansion than that of the battery material (for example, at least one of the positive electrode layer, the negative electrode layer, and the solid electrolyte layer) constituting the battery unit. Preferably, the insulating layer has a lower coefficient of thermal expansion than that of each of the positive electrode layer, the negative electrode layer, and the solid electrolyte layer. Such a constitution makes it possible to generate a compressive stress in the insulating layer to increase the strength of the battery materials when the battery materials are co-sintered in a solid state battery manufacturing process, whereby the cracks of the battery materials that may occur during charge and discharge can be particularly suppressed. The coefficient of thermal expansion of each of the battery materials may change during firing, but the magnitude relationship itself of the coefficient of thermal expansion between the battery materials does not change before and after firing. The coefficient of thermal expansion may be the coefficient of thermal expansion of each of a plurality of target layers that are present, or the coefficient of thermal expansion of a single body obtained by totally regarding the plurality of layers as the single body. Therefore, here, “the coefficient of thermal expansion of the positive electrode layer, the negative electrode layer, and the solid electrolyte layer” may be the coefficient of thermal expansion of each of the positive electrode layer, the negative electrode layer, and the solid electrolyte layer, or the coefficient of thermal expansion of a single integrated body when the positive electrode layer, the negative electrode layer, and the solid electrolyte layer are totally regarded as the single integrated body.

In a suitable aspect, the insulating layer is formed by dispersing a ceramic material in a base material composed of a glass material. That is, the insulating layer includes a continuous phase containing the glass material and a dispersed phase containing the ceramic material dispersed in the continuous phase. The insulating layer is composed of the base material composed of the glass material, whereby the coefficient of thermal expansion of the insulating layer can be further lowered. The insulating layer is formed by dispersing the ceramic material in the base material composed of the glass material, whereby the Young's modulus of the insulating layer can be further increased. Therefore, the cracks of the insulating layer that may occur during charge and discharge are likely to be particularly suppressed.

In a suitable aspect, the ceramic material constituting the insulating layer contains at least one material selected from the group consisting of alumina, zirconia, spinel, and forsterite. The ceramic material constituting the insulating layer contains the ceramic material, whereby the Young's modulus of the insulating layer is likely to be set to be higher than that of the other battery material.

In a suitable aspect, the content rate of the ceramic material in the base material composed of the glass material is 1% by weight to 30% by weight. When the content rate is 1% by weight or more, the Young's modulus of the insulating layer can be further increased, whereby the cracks of the battery materials that may occur during charge and discharge can be more effectively suppressed. When the content rate is 30% by weight or less, the coefficient of thermal expansion of the insulating layer can be lowered, whereby a larger compressive stress can be generated in the insulating layer during co-sintering, which is likely to particularly suppress the cracks of the battery materials that may occur during charge and discharge. The content rate of the ceramic material in the base material composed of the glass material is preferably 2% by weight to 25% by weight, and more preferably 3% by weight to 20% by weight.

The content rate of the ceramic material may refer to a value obtained by an energy dispersive method (EDS) using, for example, an energy dispersive X-ray analyzer (for example, JED-2200F, manufactured by JEOL Ltd.). In this case, the measurement condition may include a scanning voltage of 15 kV and an irradiation current of 10 μA.

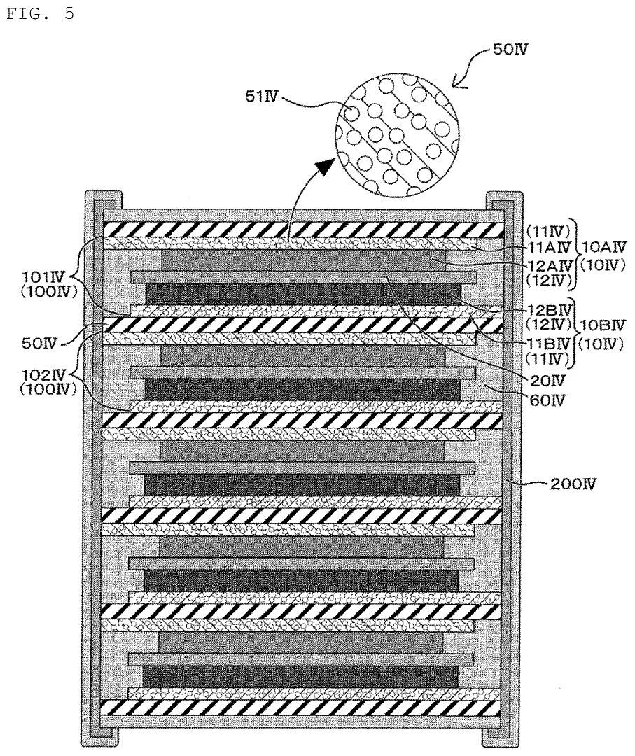

In an exemplary aspect shown in FIG. 4, an insulating layer 50III in a solid state battery 500III is composed of a mixture of a glass material and a ceramic material. Specifically, the insulating layer 50III is in a form in which a ceramic material 51III is dispersed in a base material composed of a glass material. Such a constitution is likely to increase the Young's modulus of the insulating layer 50III. In such a constitution, the coefficient of thermal expansion of the insulating layer 50III is likely to be lower than that of each of battery materials (that is, a positive electrode layer 10AIII, a negative electrode layer 10BIII, and a solid electrolyte layer 20III) constituting a battery unit 100III, whereby a compressive stress can be generated in the insulating layer 50III during sintering to further increase the strength of the battery materials. Therefore, the cracks of the battery materials that may occur during charge and discharge is likely to be more effectively suppressed.

Preferably, the Young's modulus of the insulating layer is 150 GPa to 250 GPa. When the Young's modulus is 150 GPa or more, the insulating layer is likely to have strength capable of more effectively suppressing the cracks of the battery materials that may occur during charge and discharge. When the Young's modulus is 250 GPa or less, a stress occurring between the insulating layer and the battery material constituting the battery unit can be more effectively reduced. More preferably, the Young's modulus is 160 GPa to 230 GPa, and most preferably 180 GPa to 220 GPa.

The “Young's modulus” as used herein refers to a value measured by a technique in accordance with the JIS (JIS R 1602). More specifically, the value of “Young's modulus” herein may be a value obtained by measurement using a table-top precision universal tester (model number: AGS-5kNX, manufactured by Shimadzu Corporation).

According to an exemplary aspect shown in FIG. 1, in the solid state battery 500, the insulating layer 50 is interposed between the battery units adjacent to each other. That is, the insulating layer 50 divides the battery units 100. The insulating layer 50 has ion insulating properties, whereby the movement of the ions through the solid electrolyte layer 20 can be prevented between the positive electrode layer (or the negative electrode layer) included in one battery unit 101 and the negative electrode layer (or the positive electrode layer) directly facing the positive electrode layer (or the negative electrode layer) along the stacking direction and included in the other battery unit 102. That is, the insulating layer 50 provided so as to be sandwiched between the battery units can reduce the expansion and contraction of the electrode layer due to the movement of the ions between the battery unit 101 and the battery unit 102. That is, the insulating layer between the battery units can reduce the stress that can occur in the battery material due to the expansion and contraction of an active material layer 12 during the charge and discharge of the solid state battery 500. As shown in the sectional view of FIG. 1, preferably, the insulating layer 50 is tightly provided between the battery units, and the thickness of the insulating layer 50 may be smaller than that of each of the battery units.

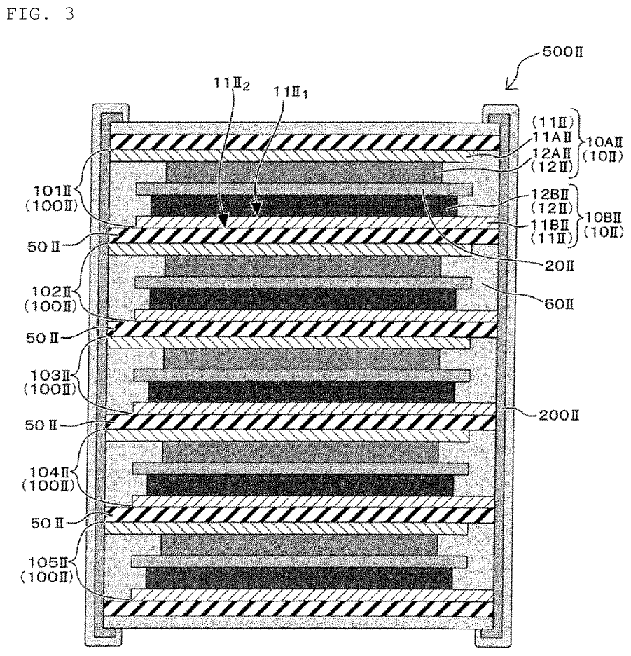

In a suitable aspect, one of the main surfaces of at least one of the positive electrode layer and the negative electrode layer of the battery unit facing each other (that is, one of the two main surfaces of the electrode layers) is in contact (particularly in direct contact) with the insulating layer. In an exemplary aspect shown in FIG. 2, a negative electrode layer 10BI in a battery unit 101I and a positive electrode layer 10AI in a battery unit 1021 are in contact (particularly in direct contact) with an insulating layer 501.

In such an aspect, the solid electrolyte layer is absent between one battery unit 101I and the other battery unit 1021 adjacent to each other (see FIG. 2). Specifically, only the insulating layer 501 is present between one battery unit 101I and the other battery unit 1021 adjacent to each other, and the solid electrolyte layer is absent. Such a constitution makes it possible to reduce the solid electrolyte layer in contact with the electrode layer that may expand and contract during charge and discharge, whereby the cracks of the battery materials can be more effectively suppressed.

As described above, the present invention includes the insulating layer between one battery unit and the other battery unit adjacent to each other in the solid state battery. In accordance with this, various aspects can be adopted as the specific aspect thereof. For example, the solid state battery may include three or more (at least three) battery units adjacent to each other along the stacking direction.

Usually, as the number of the battery units along the stacking direction increases, the number of the active material layers also increases. As the number of the active material layers increases, a large number of active material layers may expand and contract. Therefore, the degree of expansion and contraction of the active material layers may be totally greater. As the degree of expansion and contraction of the active material layers is greater, a stress that may occur in the solid electrolyte layer that may not expand and contract during the charge and discharge of the solid state battery may be greater.

In view of such circumstances, when three or more battery units are provided along the stacking direction, a function effect of dividing the battery units is exhibited. It is preferable that an insulating layer having a high Young's modulus than that of each of the battery materials constituting the battery units is provided between two of at least three battery units adjacent to each other. Such a constitution makes it possible to suitably reduce the movement of the ions between the battery units, whereby the expansion and contraction of the electrode layer that may occur during the charge and discharge of the solid state battery can be suitably reduced. The insulating layer has a higher Young's modulus than that of the battery material constituting the battery unit, whereby the insulating layer can have strength capable of suppressing the cracks of the battery materials that may occur due to deformation caused by the expansion and contraction of the electrode layer. Furthermore, the insulating layer has a high Young's modulus, whereby the propagation of a stress (strain) between the battery units can be suitably prevented, which makes it possible to suitably reduce the stress occurring in the battery materials.

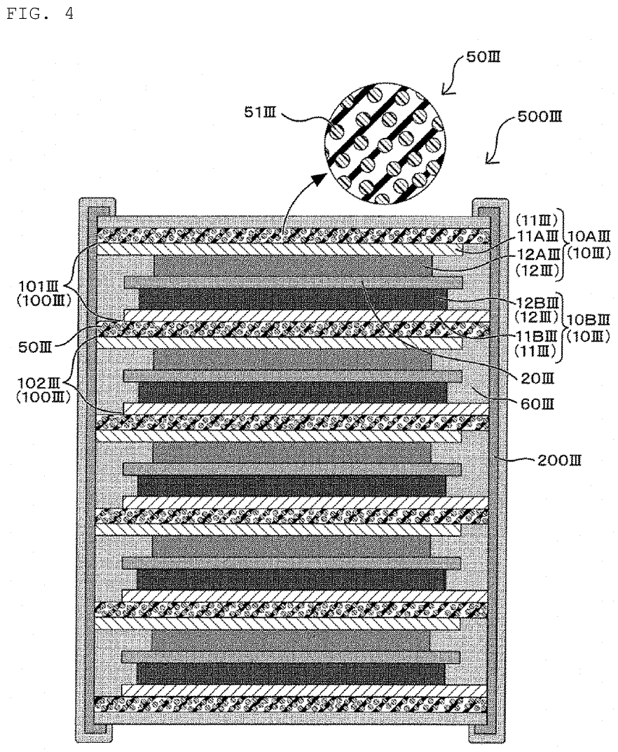

In an exemplary aspect shown in FIG. 3, at least three battery units 100II are provided along a stacking direction, and at least an insulating layer 50II is provided between the battery units 100II adjacent to each other.

Such an aspect will be described on the premise that at least one of a positive electrode layer and a negative electrode layer includes a current collecting layer in addition to an active material layer. In the aspect shown in FIG. 3, an active material layer 12II is provided on one side of a current collecting layer 11II, and an insulating layer 50II is provided on the other side of the current collecting layer 11II.

On the premise that the electrode layer includes not only the active material layer but also the current collecting layer, the active material layer may be in various forms. In an aspect, the active material layer may be provided on one main surface side of the current collecting layer, and the active material layer may also be provided on the other main surface side (see FIG. 1). However, the active material layer 12II may be provided only on one main surface 11II₁ side of the current collecting layer 11II (see FIG. 3). In this case, the insulating layer is provided between one battery unit and the other battery unit adjacent to each other in the solid state battery, the active material layer 12II is provided on one main surface 11II₁ side of the current collecting layer 11II, while the insulating layer 50II is provided on the other main surface 11II₂ side.

When the insulating layer 50II is provided on the other main surface 11II₂ side of the current collecting layer 11II, the active material layer 12II is not present on the other main surface 11II₂ side. When the active material layer 12II is not present on the other main surface 11II₂ side, the volume of the active material layer 12II when focusing on a predetermined single electrode layer can be halved as compared with the case where the active material layer 12II is present on the other main surface 11II₂ side.

When the active material layer 12II may expand and contract during the charge and discharge of the solid state battery 500II, the halving of the volume of the active material layer 12II makes it possible to halve the degree of expansion and contraction of the active material layer 12II in a predetermined single electrode layer 10II as compared with that before halving.

As described above, in the present aspect, as the volume of the active material layer 12II in the predetermined single electrode layer 10II is halved, the degree of expansion and contraction of the active material layer 12II can also be halved. Therefore, the degree of expansion and contraction of the active material layer 12II in the predetermined single electrode layer 10II can be more suitably reduced. This makes it possible to more suitably reduce a stress that may occur in the solid electrolyte 20II layer that may not expand/contract during the charge and discharge of the solid state battery 500II or may reduce the amounts of expansion and contraction with respect to each electrode layer.

In a suitable aspect, an insulating layer 50III is in a form in which a ceramic material 51III is dispersed in a base material composed of a glass material (see FIG. 4). That is, the insulating layer 50III includes a continuous phase containing a glass material and a dispersed phase 51III containing a ceramic material dispersed in the continuous phase. The insulating layer 50III is composed of the base material composed of the glass material, whereby the coefficient of thermal expansion of the insulating layer 50III can be further lowered. The insulating layer 50III is formed by dispersing the ceramic material 51III in the base material composed of the glass material, whereby the Young's modulus of the insulating layer can be further increased. Thereby, the insulating layer can have strength capable of suppressing the cracks of the battery materials that may occur due to deformation caused by the expansion and contraction of the electrode layer. Furthermore, the insulating layer can suitably prevent the propagation of a stress (strain) between the battery units, which makes it possible to suitably reduce the stress that may occur in the battery material.

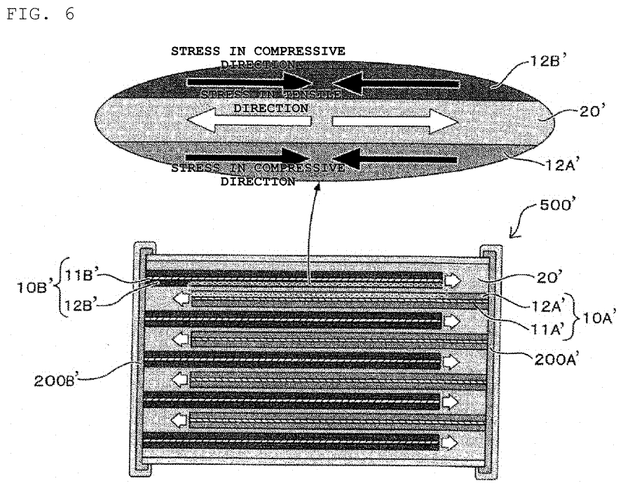

In a suitable aspect, a current collecting layer 11IV is in a porous form (see FIG. 5). That is, a large number of micro-sized pores 51IV are formed in the current collecting layer 11IV. Therefore, the Young's modulus of the porous current collecting layer 11IV can be set to be lower than the Young's modulus of the current collecting layer composed of only a solid portion.

In another suitable aspect, the current collecting layer contains a metal material having a low Young's modulus. Although not particularly limited, for example, the current collecting layer contains silver, gold, and/or aluminum and the like. In a more suitable aspect, the current collecting layer is in a porous form, and contains a metal material having a low Young's modulus.

The above constitution makes it possible to more suitably reduce a stress that may occur when a pressing force due to the expansion and contraction of the active material layer 12IV along the stacking direction is transmitted to the current collecting layer 11IV (see FIG. 5). Therefore, the stress of the battery materials occurring due to the expansion and contraction of the battery unit 100IV along the stacking direction can be more suitably reduced. Therefore, the cracks of the battery materials that may occur due to the expansion and contraction of the electrode layer during the charge and discharge of the solid state battery can be more suitably suppressed.

In a suitable aspect, the Young's modulus of the current collecting layer is 130 GPa or less. When the Young's modulus is 130 GPa or less, a stress occurring between the current collecting layer and the battery material can be more effectively reduced. Preferably, the Young's modulus is 100 GPa or less, and more preferably 90 GPa or less. The Young's modulus of the current collecting layer refers to a value measured by the same method as that of the Young's modulus of the insulating layer described above.

[Method for Manufacturing Solid State Battery of the Present Invention]

Hereinafter, a method for manufacturing a solid state battery according to an embodiment of the present invention will be described.

The present manufacturing method corresponds to a method for manufacturing the above-described solid state battery according to an embodiment of the present invention.

The solid state battery according to an embodiment of the present invention can be manufactured by combining a green sheet method using a green sheet with a printing method such as a screen printing method. In one aspect, a predetermined stacked body is formed by the green sheet method, and a solid electrolyte layer sheet or an insulating layer sheet is provided in a side part region of the stacked body to be formed by screen printing, whereby the solid state battery according to an embodiment of the present invention can be finally manufactured. Hereinafter, the description will be made on the premise of the aspect, but the present invention is not limited thereto, and a predetermined stacked body may be formed by the screen printing method or the like.

(Step of Forming Unfired Stacked Body)

First, a solid electrolyte layer paste, a positive electrode active material layer paste, a positive electrode current collecting layer paste, a negative electrode active material layer paste, a negative electrode current collecting layer paste, an insulating layer paste, and a protective layer paste are coated on substrates (for example, PET films) used as supporting substrates.

Each paste can be produced by wet-mixing a predetermined constituent material for each layer appropriately selected from the group consisting of a positive electrode active material, a negative electrode active material, a conductive material, a solid electrolyte material, an insulating material, and a sintering aid, with an organic vehicle obtained by dissolving an organic material in a solvent. The positive electrode active material layer paste contains, for example, a positive electrode active material, an electron conductive material, a solid electrolyte material, an organic material, and a solvent.

The negative electrode active material layer paste contains, for example, a negative electrode active material, an electron conductive material, a solid electrolyte material, an organic material, and a solvent. The solid electrolyte layer paste contains, for example, a solid electrolyte material, a sintering aid, an organic material, and a solvent. The insulating layer paste contains, for example, an insulating material, a sintering aid, an organic material, and a solvent. As the positive electrode current collecting layer paste and the negative electrode current collecting layer paste, for example, at least one may be selected from the group consisting of silver, palladium, gold, platinum, aluminum, copper, and nickel. The protective layer paste contains, for example, an insulating material, an organic material, and a solvent.

In the wet-mixing, media can be used, and specifically, a ball mill method or a visco mill method or the like can be used. Meanwhile, a wet-mixing method that does not use media may be used, and a sand mill method, a high-pressure homogenizer method, or a kneader dispersion method or the like may be used.

The supporting substrate is not particularly limited as long as it can support the unfired stacked body, and for example, a substrate composed of a polymer material such as polyethylene terephthalate can be used. When the unfired stacked body is subjected to a firing step while being held on the substrate, the substrate that may be used exhibits heat resistance to a firing temperature.

As the solid electrolyte material contained in the solid electrolyte layer paste, as described above, powders composed of a lithium-containing phosphate compound having a NASICON structure, an oxide having a perovskite structure, and/or an oxide having a garnet-type or garnet-type similar structure may be used.

As the positive electrode active material contained in the positive electrode active material layer paste, for example, at least one selected from the group consisting of a lithium-containing phosphate compound having a NASICON-type structure, a lithium-containing phosphate compound having an olivine-type structure, a lithium-containing layered oxide, and a lithium-containing oxide having a spinel-type structure, and the like may be used.

The negative electrode active material contained in the negative electrode active material layer paste may be at least one negative electrode active material selected from the group consisting of an oxide containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing phosphate compound having an olivine-type structure, and a lithium-containing oxide having a spinel-type structure, and the like. The negative electrode active material layer paste may contain, in addition to the negative electrode active material, the material contained in the above-described solid electrolyte paste and/or the electron conductive material and the like.

As the insulating material contained in the insulating layer paste, for example, a glass material, a ceramic material, and/or a sintering aid and the like may be used. As the insulating material contained in the protective layer paste, for example, at least one selected from the group consisting of a glass material, a ceramic material, a thermosetting resin material, and a photocurable resin material and the like may be used.

The organic material contained in the paste used for manufacturing the solid state battery is not particularly limited, but at least one polymeric material selected from the group consisting of a polyvinyl acetal resin, a cellulose resin, a polyacrylic resin, a polyurethane resin, a polyvinyl acetate resin, and a polyvinyl alcohol resin and the like can be used. The paste may contain a solvent. The solvent is not particularly limited as long as it can dissolve the organic material, and for example, toluene and/or ethanol and the like may be used.

As the sintering aid, at least one selected from the group consisting of lithium oxide, sodium oxide, potassium oxide, boron oxide, silicon oxide, bismuth oxide, and phosphorus oxide may be used.

By drying the pastes coated on the substrates (for example, the PET films) on a hot plate heated to 30° C. or higher and 50° C. or lower, a solid electrolyte layer sheet, positive and negative electrode sheets, and an insulating layer sheet are formed to have predetermined thicknesses on the substrates.

Next, each sheet is peeled off from the substrate. After peeling off, constituent element sheets of one battery unit are stacked in order along a stacking direction, and an insulating layer sheet is then stacked. Then, along the stacking direction, constituent element sheets of the other battery unit are stacked in order on the insulating layer sheet. After stacking and before subsequent pressing, a solid electrolyte layer sheet or an insulating layer sheet may be provided in the side part region of the electrode sheet by screen printing. Next, thermocompression bonding at a predetermined pressure (for example, about 50 MPa or more and about 100 MPa or less) and subsequent isotropic pressure pressing at a predetermined pressure (for example, about 150 MPa or more and about 300 MPa or less) may be carried out. From the above, a predetermined stacked body can be formed.

(Firing Step)

In a firing step, the unfired stacked body is subjected to firing. Although the followings are merely examples, the firing may be carried out by removing an organic material in a nitrogen gas atmosphere containing an oxygen gas or in the air, for example, at 500° C., followed by heating in a nitrogen gas atmosphere or in the air, for example, 550° C. or higher and 1000° C. or lower. The firing may be performed while the unfired stacked body is pressurized in the stacking direction (in some cases, the stacking direction and a direction perpendicular to the stacking direction).

Next, terminals are attached to the obtained stacked body. The terminals are provided so as to be electrically connectable to the positive electrode layer and the negative electrode layer. For example, it is preferable to form the terminals by sputtering or the like. Although not particularly limited, the terminal is preferably composed of at least one selected from silver, gold, platinum, aluminum, copper, tin, and nickel. Furthermore, it is preferable to provide a protective layer such that the terminals are not covered by sputtering or spray coating or the like.

(Regarding Production of Distinguishing Portion in the Present Invention)

The insulating layer having a higher Young's modulus than that of the battery material constituting the battery unit may be produced by any method as long as the insulating layer itself has a desired Young's modulus.

Although not particularly limited, for example, the insulating layer paste may be prepared by wet-mixing a ceramic material (for example, alumina) having a high Young's modulus with an organic vehicle. Alternatively, the insulating layer paste may be prepared by wet-mixing the glass material and the ceramic material with the organic vehicle such that the particulate ceramic material is dispersed in the glass material.

The current collecting layer having a porous form can be obtained, for example, by using a resin raw material paste that can disappear after firing so as to form a porous form. For example, a paste composed of an organic vehicle may be used to form a porous form. In such a case, a portion to which such a paste is applied can disappear during firing, whereby a desired current collecting layer having a porous form can be obtained. Similarly, a current collecting layer having a porous form can be obtained by using a raw material paste containing a resin filler that can disappear during firing so as to form a porous form.

Although the embodiments of the present invention have been described above, they are merely examples. Therefore, those skilled in the art will easily understand that the present invention is not limited to this, and various aspects can be considered without changing the gist of the present invention.

For example, in the above description, for example, the solid state battery exemplified in FIG. 1 and the like has been mainly described, but the present invention is not necessarily limited to this. In the present invention, the solid state battery can be similarly applied, which includes at least two battery units provided along the stacking direction, and the insulating layer having a higher Young's modulus than that of the battery material constituting the battery unit and provided between one battery unit and the other battery unit adjacent to each other along the stacking direction.

The solid state battery according to an embodiment of the present invention can be used in various fields in which electricity storage is expected. Although the followings are merely examples, the solid state battery according to an embodiment of the present invention can be used in electricity, information and communication fields where mobile devices and the like are used (for example, mobile device fields, such as mobile phones, smart phones, laptop computers, digital cameras, activity meters, arm computers, and electronic papers), domestic and small industrial applications (for example, the fields such as electric tools, golf carts, domestic robots, caregiving robots, and industrial robots), large industrial applications (for example, the fields such as forklifts, elevators, and harbor cranes), transportation system fields (for example, the fields such as hybrid vehicles, electric vehicles, buses, trains, electric assisted bicycles, and two-wheeled electric vehicles), electric power system applications (for example, the fields such as various power generation systems, load conditioners, smart grids, and home-installation type power storage systems), medical care applications (the medical care instrument fields such as earphone acoustic aids), medicinal applications (the fields such as dosing management systems), IoT fields, and space and deep sea applications (for example, the fields such as spacecraft and research submarines).

### DESCRIPTION OF REFERENCE SYMBOLS

500: Solid state battery
100: Battery unit
101: (One) electrode unit
102: (Other) electrode unit
10: Electrode layer
10A: Positive electrode layer
10B: Negative electrode layer
11: Current collecting layer
11A: Positive electrode current collecting layer
11B: Negative electrode current collecting layer
12: Electrode active material layer
12A: Positive electrode active material layer
12B: Negative electrode active material layer
20,60: Solid electrolyte layer
50: Insulating layer

1. A solid state battery comprising:
at least two battery units arranged adjacent to each other along a stacking direction, each of the at least two battery units including a positive electrode layer, a negative electrode layer, and a solid electrolyte layer interposed between the positive electrode layer and the negative electrode layer; and
an insulating layer between two adjacent battery units of the at least two battery units along the stacking direction, wherein the insulating layer has a higher Young's modulus than that of each of the two adjacent battery units.

2. The solid state battery according to claim 1, wherein the Young's modulus of the insulating layer is 150 GPa to 250 GPa.

3. The solid state battery according to claim 1, wherein the insulating layer has a lower coefficient of thermal expansion than that of the two adjacent battery units.

4. The solid state battery according to claim 3, wherein the insulating layer has a lower coefficient of thermal expansion than that of each of the positive electrode layer, the negative electrode layer, and the solid electrolyte layer of each of the two adjacent battery units.

5. The solid state battery according to claim 1, wherein the insulating layer has a higher Young's modulus than that of each of the positive electrode layer, the negative electrode layer, and the solid electrolyte layer of each of the two adjacent battery units.

6. The solid state battery according to claim 1, wherein the insulating layer is composed of a material having electron insulating properties and ion insulating properties.

7. The solid state battery according to claim 1, wherein the insulating layer comprises a base material composed of a glass material having a ceramic material dispersed therein.

8. The solid state battery according to claim 7, wherein the ceramic material contains at least one selected from the group consisting of alumina, zirconia, spinel, and forsterite.

9. The solid state battery according to claim 7, wherein a content of the ceramic material in the base material is 1% by weight to 30% by weight.

10. The solid state battery according to claim 1, wherein a main surface of at least one of the positive electrode layer and the negative electrode layer that face each other of the two adjacent battery units is in contact with the insulating layer.

11. The solid state battery according to claim 1, wherein a main surface of each of the positive electrode layer and the negative electrode layer that face each other of the two adjacent battery units are in contact with the insulating layer.

12. The solid state battery according to claim 1, wherein:
the solid state battery includes at least three battery units arranged along the stacking direction; and
the insulating layer is between the battery units that adjacent to each other among the at least three battery units.

13. The solid state battery according to claim 1, wherein:
at least one of the positive electrode layer and the negative electrode layer of at least one of the at the least two battery units includes an active material layer and a current collecting layer;
the active material layer is on a first side of the current collecting layer; and
the insulating layer is on a second side of the current collecting layer opposite the first side.

14. The solid state battery according to claim 13, wherein the current collecting layer is a porous current collecting layer.

15. The solid state battery according to claim 1, wherein the positive electrode layer and the negative electrode layer are constructed to occlude and release lithium ions.
